(19) United States
(12) Patent Application Publication
(10) Pub. No.: US 2026/0181295 A1
(43) Pub. Date: Jun. 25, 2026

(54) WEARABLE ELECTRONIC DEVICE ASSEMBLY

(71) Applicant: SAMSUNG ELECTRONICS CO., LTD., Suwon-si (KR)

(72) Inventors: Myoungsung SIM, Suwon-si (KR); Taeyoung PARK, Suwon-si (KR); Jihoon SONG, Suwon-si (KR); Jeock LEE, Suwon-si (KR); Myungcheol LEE, Suwon-si (KR); Byounghee LEE, Suwon-si (KR); Hochul HWANG, Suwon-si (KR)

(21) Appl. No.: 19/545,562

(22) Filed: Feb. 20, 2026

Related U.S. Application Data
(63) Continuation of application No. PCT/KR2024/010638, filed on Jul. 23, 2024.

(30) Foreign Application Priority Data
Aug. 21, 2023 (KR) 10-2023-0109418
Oct. 18, 2023 (KR) 10-2023-0139532

(51) Int. Cl. H04R 1/02; H04R 1/08; H04R 1/10; H04R 3/00

(52) U.S. Cl. CPC H04R 1/025; H04R 1/026; H04R 1/086; H04R 1/10; H04R 3/00; H04R 2460/17

(57) ABSTRACT

A wearable electronic device assembly includes: a wearable electronic device having a speaker therein; and a case configured to accommodate the wearable electronic device. The wearable electronic device includes: a housing having the speaker therein; and a microphone spaced apart from the speaker inside the housing. The case includes: a lower body defining a space therein for accommodating the housing; an upper body rotatably coupled to the lower body; and a protrusion portion protruding outwardly from the lower body or the upper body and is configured to be seated on the protrusion while the upper body is in a closed state with respect to the lower body.

### CROSS-REFERENCE TO RELATED APPLICATIONS

This application is a continuation application, claiming priority under § 365(c), of an International application No. PCT/KR2024/010638, filed on Jul. 23, 2024, which claims priority to Korean Patent Application No. 10-2023-0109418, filed on Aug. 21, 2023, and Korean Patent Application No. 10-2023-0139532, filed on Oct. 18, 2023, and all the benefits accruing therefrom under 35 U.S.C. § 119, the contents of which in their entireties are herein incorporated by reference.

### BACKGROUND

### (1) Field

Various embodiments set forth herein relate to a wearable electronic device assembly, for example, to an assembly including a wearable electronic device and a case for accommodating the wearable electronic device.

### (2) Description of the Related Art

With the advancement of electronic technology, various types of wearable electronic devices are desired to be more compact and equipped with diverse functionalities. To meet these demands, various electronic components may be mounted on printed circuit boards (PCBs).

Components associated with at least one sound effect may be mounted on a printed circuit board of a wearable electronic device. The components associated with sound effects may include, for example, a speaker and a microphone, and these components may be mounted inside a housing of the wearable electronic device in various shapes and arrangements to correspond to various exterior designs of the wearable electronic device.

The wearable electronic device including a speaker and a microphone may correspond to, for example, an earphone (or earset, headphone, or headset), or a hearing aid. The wearable electronic device may be worn close to the user's ears, and to this end, the wearable electronic device may be manufactured in a compact size. The wearable electronic device may be a wireless type including an antenna configured to transmit or receive a signal to or from an external electronic device. The wearable electronic device may be a wired type including a cable connected to an external electronic device.

### SUMMARY

The wearable electronic device assembly according to an embodiment of the disclosure includes a wearable electronic device including a speaker, and a case configured to accommodate the wearable electronic device, where the wearable electronic device includes a housing in which the speaker is disposed, and a microphone disposed in the housing and spaced apart from the speaker, where the case includes a lower body defining a space configured to accommodate the housing, an upper body rotatably coupled to the lower body, and a protrusion portion protruding outwardly from the lower body or the upper body where at least a portion of the housing is configured to be seated on the protrusion while the upper body is in a closed state with respect to the lower body.

The wearable electronic device assembly according to an embodiment of the disclosure includes a wearable electronic device including a speaker disposed, and a case configured to accommodate the wearable electronic device, where the wearable electronic device may include a housing in which the speaker is disposed, and a microphone disposed in the housing and spaced apart from the speaker, where the case includes a lower body defining a space configured to accommodate the housing, an upper body rotatably coupled to the lower body, and a recess defined at the upper body and where at least a portion of the housing configured to be seated in the recess.

The wearable electronic device assembly according to an embodiment of the disclosure, a wearable electronic device assembly includes a wearable electronic device including a speaker, and a case configured to accommodate the wearable electronic device, where the case includes a lower body defining a space configured to accommodate the wearable electronic device, an upper body rotatably coupled to the lower body, and a first magnet, where the wearable electronic device includes a housing in which the speaker is disposed, a microphone disposed spaced apart from the speaker inside the housing, and a second magnet disposed inside the housing and configured to be magnetically attracted to each other.

### BRIEF DESCRIPTION OF THE DRAWINGS

FIG. 1 is a block diagram illustrating an electronic device in a network environment according to various embodiments.

FIG. 2 is a block diagram of an audio module according to various embodiments.

FIG. 3 is a perspective diagram of a wearable electronic device assembly according to an embodiment of the disclosure.

FIG. 4A is a perspective diagram of a case in an open state according to an embodiment of the disclosure.

FIG. 4B is a perspective diagram of a state in which a wearable electronic device is accommodated inside a case according to an embodiment of the disclosure.

FIG. 5 is a diagram of a wearable electronic device according to an embodiment of the disclosure.

FIG. 6A is a perspective diagram of a wearable electronic device assembly according to an embodiment of the disclosure.

FIG. 6B is a side diagram of a wearable electronic device assembly according to an embodiment of the disclosure.

FIG. 6C is a side diagram of a wearable electronic device assembly according to an embodiment of the disclosure.

FIG. 6D is a side diagram of a wearable electronic device assembly according to an embodiment of the disclosure.

FIG. 7A illustrates a portion of a wearable electronic device according to an embodiment of the disclosure.

FIG. 7B illustrates a portion of a wearable electronic device according to an embodiment of the disclosure.

FIG. 8 is a sectional diagram of a wearable electronic device assembly according to an embodiment of the disclosure.

FIG. 9 is a conceptional diagram of a magnet according to an embodiment of the present disclosure.

FIG. 10 is a control block diagram of a wearable electronic device assembly according to an embodiment of the disclosure.

FIG. 11 is a diagram illustrating an effect of a wearable electronic device assembly according to an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms and words used in the following description and claims are not limited to a reference meaning, but may be used to clearly and consistently describe an embodiment of the disclosure. Accordingly, it will be apparent to those skilled in the art that the following description of various implementations of the disclosure is provided for the purpose of explanation and not for the purpose of limiting the disclosure, which defines the scope of the rights and equivalents thereof.

It will be understood that when an element is referred to as being the following element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, escribe various elements, components, regions, layers and/or sections, these elements, components, regions, component, region, layer or section without departing from the teachings herein.

The terminology used herein is for the purpose of describing particular embodiments only and is not intended to be limiting. As used herein, “a”, “an,” “the,” and at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “a component surface” could be understood to include one or more of the surfaces of the component herein, “a”, “an,” “the,” and at least one” do not denote a limitation of quantity, and are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

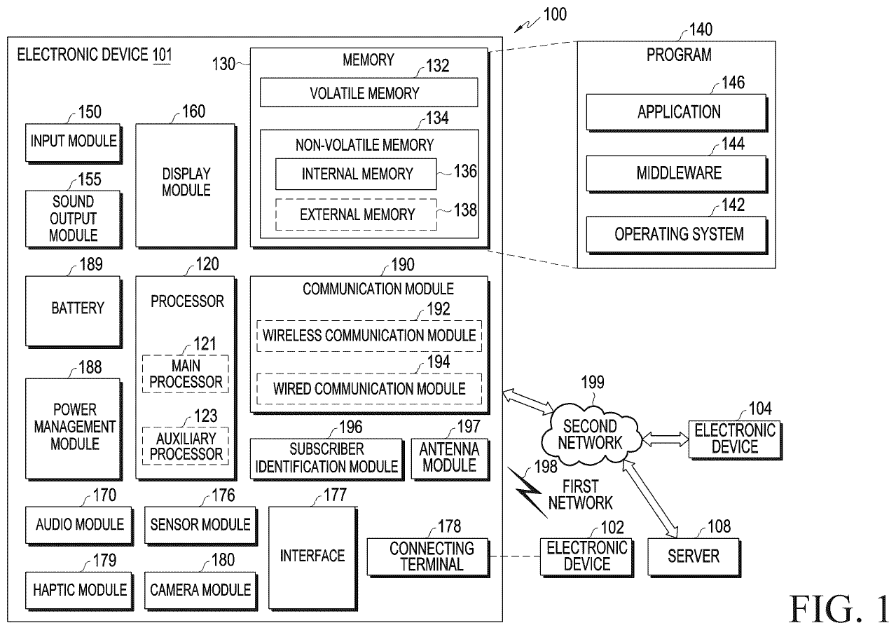

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

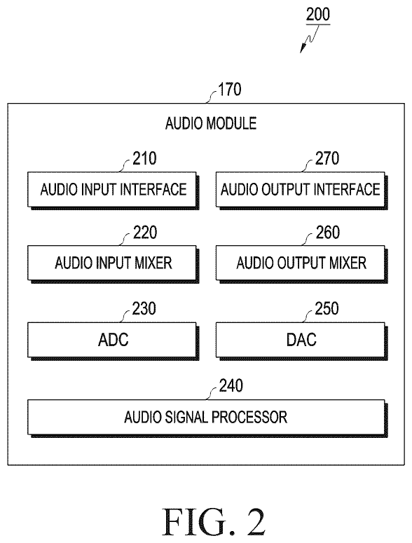

FIG. 2 is a block diagram 200 of an audio module 170 according to various embodiments. Referring to FIG. 2, an embodiment of the audio module 170 may include, for example, an audio input interface 210, an audio input mixer 220, an analog to digital converter (ADC) 230, an audio signal processor 240, a digital to analog converter (DAC) 250, an audio output mixer 260, or an audio output interface 270.

The audio input interface 210 may receive an audio signal corresponding to a sound acquired from the outside of the electronic device 101 through a microphone (e.g., a dynamic microphone, a condenser microphone, or a piezo microphone) configured as a portion of the input module 150 or separately from the electronic device 101. For example, in case that the audio signal is acquired from an external electronic device 102 (e.g., a headset or a microphone), the audio input interface 210 may be connected to the external electronic device 102 directly through a connecting terminal 178 or wirelessly (e.g., Bluetooth communication) through a wireless communication module 192 so as to receive an audio signal. According to an embodiment, the audio input interface 210 may receive a control signal (e.g., a volume adjustment signal received through an input button) associated with the audio signal acquired from the external electronic device 102. The audio input interface 210 may include multiple audio input channels and receive different audio signals for each corresponding audio input channel among the multiple audio input channels. According to an embodiment, additionally or alternatively, the audio input interface 210 may receive an audio signal from another component (e.g., the processor 120 or the memory 130) of the electronic device 101.

The audio input mixer 220 may synthesize multiple input audio signals into at least one audio signal. For example, according to an embodiment, the audio input mixer 220 may synthesize multiple input analog audio signals input through the audio input interface 210 into at least one analog audio signal.

The ADC 230 may convert an analog audio signal into a digital audio signal. For example, according to an embodiment, the ADC 230 may convert an analog audio signal received through the audio input interface 210 or additionally or alternatively, an analog audio signal synthesized through the audio input mixer 220 into a digital audio signal.

The audio signal processor 240 may perform various processing with respect to a digital audio signal input through the ADC 230 or a digital signal received from another component of the electronic device 101. For example, according to an embodiment, the audio signal processor 240 may perform sampling rate modification, application of one or more filters, interpolation processing, amplification or attenuation of entire or partial frequency bands, noise processing (e.g., noise or echo attenuation), channel conversion (e.g., switching between mono and stereo), mixing, or extraction of a designated signal for one or more digital audio signals. According to an embodiment, one or more functions of the audio signal processor 240 may be implemented as the form of equalizer.

The DAC 250 may convert a digital audio signal into an analog audio signal. For example, according to an embodiment, the DAC 250 may convert a digital audio signal processed by the audio signal processor 240 or acquired from another component (e.g., the processor 120 or the memory 130) of the electronic device 101 into an analog audio signal.

The audio output mixer 260 may synthesize multiple audio signals to be output into at least one audio signal. For example, according to an embodiment, the audio output mixer 260 may synthesize an audio signal having been converted to analog through the DAC 250 and another analog audio signal (e.g., an analog audio signal received through the audio input interface 210) into at least one analog audio signal.

The audio output interface 270 may output an analog audio signal converted through the DAC 250 or additionally or alternatively, an analog audio signal synthesized by the audio output mixer 260 to the outside of the electronic device 101 through a sound output module 155. The sound output module 155 may include a speaker such as a dynamic driver or a balanced armature driver, or a receiver. According to various embodiments, the sound output module 155 may include multiple speakers. Here, the audio output interface 270 may output audio signals having multiple different channels (e.g., stereo or 5.1 channels) through some speakers among the multiple speakers. According to an embodiment, the audio output interface 270 may be connected to the external electronic device 102 (e.g., an external speaker or a headset) directly through the connecting terminal 178 or wirelessly through the wireless communication module 192 so as to output an audio signal.

According to an embodiment, the audio module 170 may not separate the audio input mixer 220 or the audio output mixer 260 and may generate at least one digital audio signal by synthesizing multiple digital audio signals by using at least one function of the audio signal processor 240.

According to an embodiment, the audio module 170 may include an audio amplifier (not shown) (e.g., a speaker amplification circuit) capable of amplifying an analog audio signal input through the audio input interface 210 or an audio signal to be output through the audio output interface 270. According to an embodiment, the audio amplifier may be implemented as a module separate from the audio module 170.

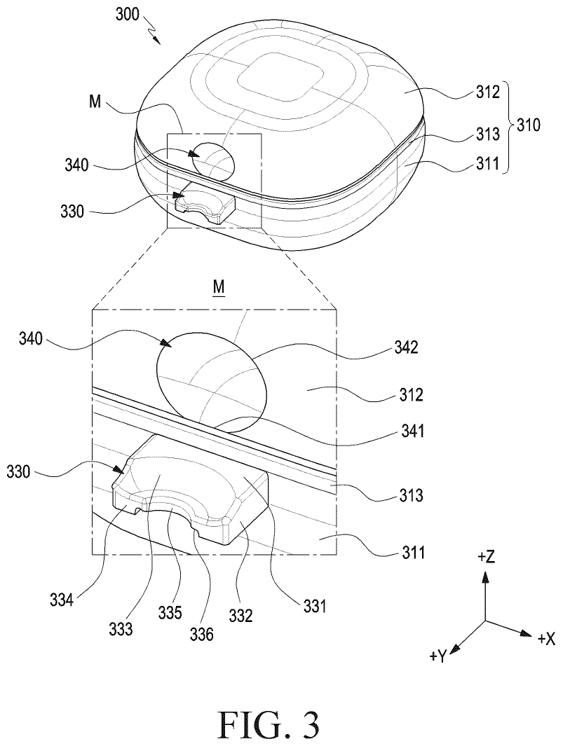

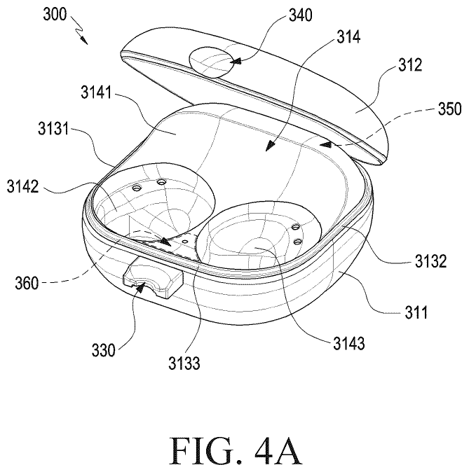

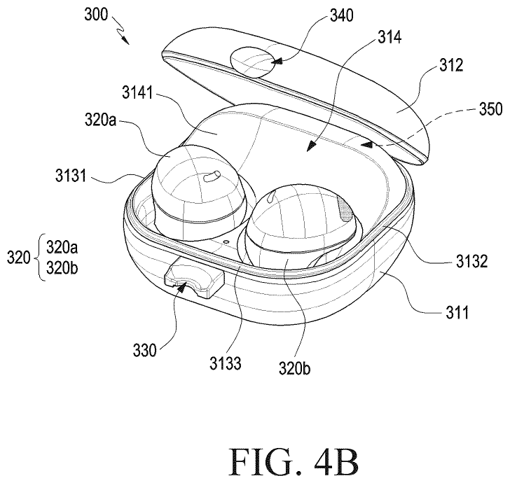

FIG. 3 is a perspective diagram of a wearable electronic device assembly 300. Components to be described with reference to FIG. 3 may be entirely or partially identical to components having been described with reference to FIGS. 1 and 2. Components to be described with reference to FIG. 3 may be entirely or partially identical to components to be described with reference to FIGS. 4A to 11.

According to an embodiment, the wearable electronic device assembly 300 may include a case 310. The case 310 may define a space therein. A wearable electronic device (e.g., the wearable electronic device 320 in FIG. 4B) may be accommodated inside the case 310.

According to an embodiment, the case 310 may include a lower body 311. The case 310 may include an upper body 312. The case 310 may include a boundary portion 313. The upper body 312 may be disposed on an upper side of the lower body 311. The lower body 311 and the upper body 312 may be coupled through a hinge (e.g., a hinge 350 in FIG. 4A). The upper body 312 may be rotated about the hinge 350 with respect to the lower body 311. When the upper body 312 is rotated with respect to the lower body 311, an inner space of the case 310 may be opened. The boundary portion 313 may be a part of the case 310 formed between the lower body 311 and the upper body 312. The boundary portion 313 may be a part of the lower body 311 and may be a part of an edge of the lower body 311.

According to an embodiment, the wearable electronic device assembly 300 may include a protrusion 330. The protrusion 330 may protrude from the case 310. The protrusion 330 may protrude toward the outside of the case 310. The protrusion 330 may protrude from the lower body 311. The protrusion 330 may be located on a lower side of the boundary portion 313.

According to an embodiment, the wearable electronic device assembly 300 may include a recess 340. The recess 340 may be recessed into the case 310. The recess 340 may be recessed in a direction toward the inner space of the case 310. The recess 340 may be recessed from the upper body 312. The recess 340 may be located on an upper side of the boundary portion 313.

According to an embodiment, the protrusion 330 may include a first surface 331. The first surface 331 may protrude in a direction from the case 310 toward the outside of the case 310. The protrusion 330 may include a second surface 332. The second surface 332 may protrude in a direction from the case 310 toward the outside of the case 310. The first surface 331 and the second surface 332 may extend in a direction intersecting each other.

According to an embodiment, the protrusion 330 may include a seating portion 333. The seating portion 333 may be connected to the first surface 331 and the second surface 332. The seating portion 333 may be formed concavely in a direction toward the case 310. The seating portion 333 may have an arch shape.

According to an embodiment, the protrusion 330 may include a third surface 334. The third surface 334 may be connected to the second surface 332. The third surface 334 may extend in a direction intersecting with the direction in which the second surface 332 protrudes from the case 310. The third surface 334 may be connected to the seating portion 333. The third surface 334 may extend downward from an end portion of the seating portion 333. Two third surfaces 334 may be arranged spaced apart from each other. A groove 335 may be configured between the pair of third surfaces 334 spaced apart from each other. The protrusion 330 may include the groove 335. The groove 335 may be formed concavely toward the case 310. The groove 335 may be formed in a concave end of the seating portion 333. The groove 335 may be formed concavely in a direction toward the case 310 based on the third surface 334. The groove 335 may be formed between a pair of third surfaces 334. The protrusion 330 may include a stepped portion 336. The stepped portion 336 may be formed to be recessed into the third surface 334. The stepped portion 336 may be formed at a position corresponding to the groove 335.

According to an embodiment, the recess 340 may include a first portion 341 and a second portion 342. The first portion 341 may be a portion of the recess 340 that is in contact with or adjacent to the boundary portion 313. The second portion 342 may be a portion of the recess 340 that extends from the first portion 341. The first portion 341 may be a portion of the recess 340 that extends parallel to the boundary portion 313. The second portion 342 may be a portion of the recess 340 that is connected to the first portion 341 and has an arc-shaped peripheral surface.

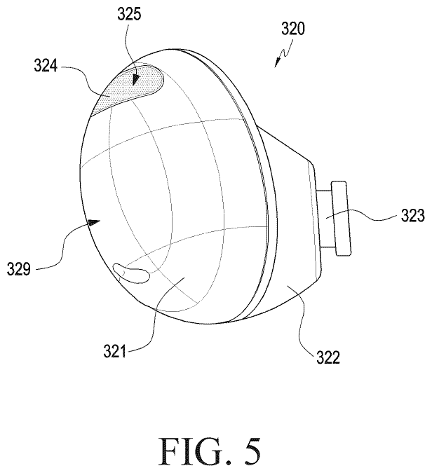

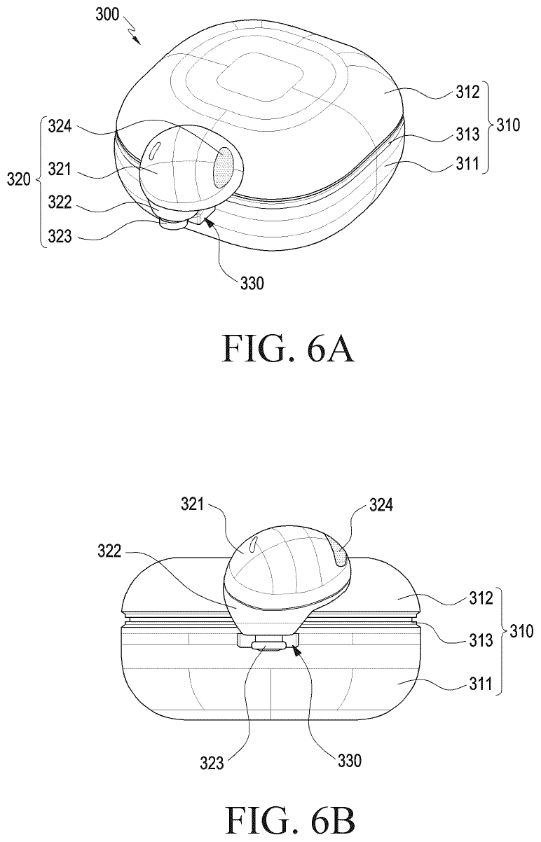

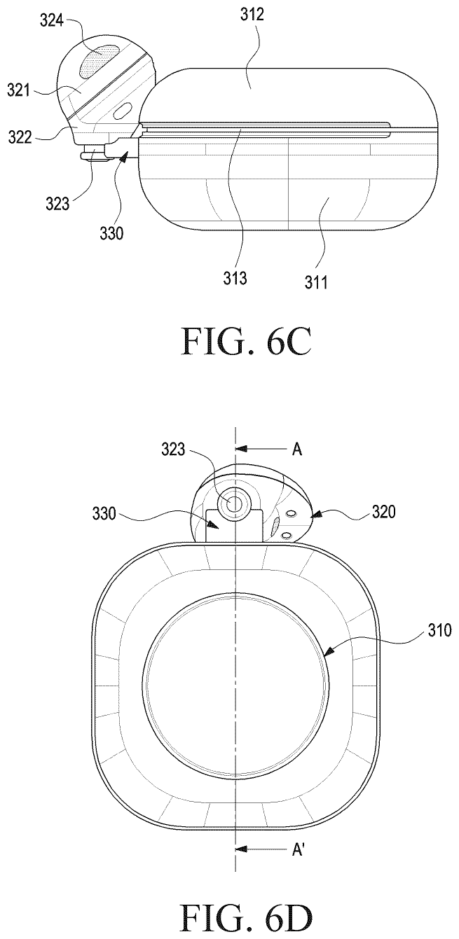

FIG. 4A is a diagram illustrating the case 310 opened while the wearable electronic device 320 is not accommodated therein. FIG. 4B is diagram illustrating the case 310 opened while the wearable electronic device 320 is accommodated therein. FIG. 5 is a diagram of the wearable electronic device 320. Components to be described with reference to FIGS. 4A, 4B, and 5 may be entirely or partially identical to components having been described with reference to FIGS. 1 to 3. Components to be described with reference to FIGS. 4A, 4B, and 5 may be entirely or partially identical to components to be described with reference to FIGS. 6A to 11.

According to an embodiment, the upper body 312 may be rotatably coupled to the lower body 311. The wearable electronic device assembly 300 may include a hinge 350. The hinge 350 may couple the lower body 311 and the upper body 312. When the upper body 312 is rotated in a direction away from the lower body 311, the protrusion 330 and the recess 340 may move away from each other.

According to an embodiment, the case 310 may include an inner body 314. The inner body 314 may be disposed inside the case 310. The inner body 314 may be disposed inside the lower body 311. When the upper body 312 is rotated in a direction away from the lower body 311, the inner body 314 may be exposed to the outside of the case 310.

According to an embodiment, the inner body 314 may include an accommodating body 3141. The accommodating body 3141 may be disposed inside the lower body 311. The inner body 314 may include a first accommodating portion 3142. The first accommodating portion 3142 may be formed to be recessed into the accommodating body 3141. The inner body 314 may include a second accommodating portion 3143. The second accommodating portion 3143 may be formed to be recessed into the accommodating body 3141. The first accommodating portion 3142 and the second accommodating portion 3143 may be spaced apart from each other. Each of a pair of wearable electronic devices 320 may be disposed in a space defined by a corresponding one of the first accommodating portion 3142 and the second accommodating portion 3143.

According to an embodiment, the boundary portion 313 may include a first boundary portion 3131. The first boundary portion 3131 may face the upper body 312. The boundary portion 313 may further include a second boundary portion 3132. The second boundary portion 3132 may face the upper body 312. The first boundary portion 3131 and the second boundary portion 3132 may extend in a direction parallel to each other. The first boundary portion 3131 may be formed on one side of the lower body 311, and the second boundary portion 3132 may be formed on an opposite side of the lower body 311. The boundary portion 313 may include a third boundary portion 3133. The third boundary portion 3133 may connect the first boundary portion 3131 and the second boundary portion 3132. The third boundary portion 3133 may be disposed between the protrusion 330 and the recess 340.

According to an embodiment, the wearable electronic device assembly 300 may include a first magnet 360. The first magnet 360 may be disposed inside the case 310. The first magnet 360 may be disposed inside the lower body 311. The first magnet 360 may be disposed between the first accommodating portion 3142 and the second accommodating portion 3143. The first magnet 360 may be disposed at a corresponding position between the protrusion 330 and the recess 340. The first magnet 360 may be disposed at a position corresponding to the third boundary portion 3133.

According to an embodiment, the wearable electronic device assembly 300 may include a wearable electronic device 320. The wearable electronic device 320 may include a first wearable electronic device 320a and a second wearable electronic device 320b. Each of the pair of wearable electronic devices 320a and 320b may be worn on a user's right ear and a user's left ear, respectively. The first wearable electronic device 320a may be seated in the first accommodating portion 3142. The second wearable electronic device 320b may be seated in the second accommodating portion 3143.

According to an embodiment, the wearable electronic device 320 may include a housing 329. A space may be defined or formed inside the housing 329. The housing 329 may include a first housing 321 and a second housing 322. The first housing 321 and the second housing 322 may be formed integrally. The wearable electronic device 320 may include a port 323. The port 323 may protrude from the housing 329. The wearable electronic device 320 may include a grille 324. The wearable electronic device 320 may include a microphone 325. The microphone 325 may be disposed inside the housing 329. Sound outside the housing 329 may pass through the grille 324 and be picked up by the microphone 325.

According to an embodiment, the wearable electronic device 320 may be seated in the accommodating portion 3142 or 3143 to cause the port 323 to face downward.

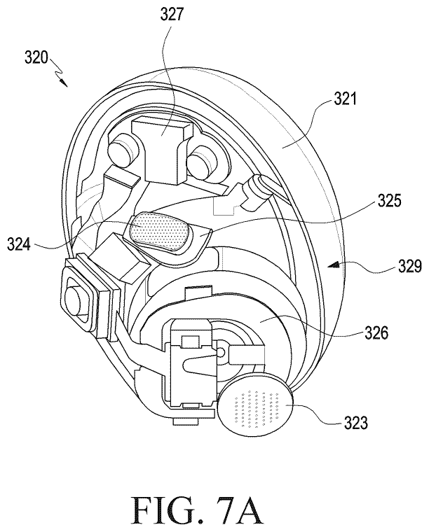

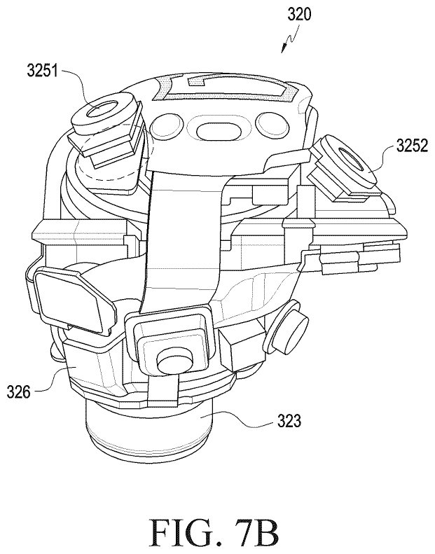

FIG. 6A is a perspective diagram of a wearable electronic device 320 seated on the outside of the case 310. FIG. 6B is a front view of FIG. 6A. FIG. 6C is a side view of FIG. 6A. FIG. 6D is a bottom view of FIG. 6A. Components to be described with reference to FIGS. 6A to 6D may be entirely or partially identical to components having been described with reference to FIGS. 1 and 5. Components to be described with reference to FIGS. 6A to 6D may be entirely or partially identical to components to be described with reference to FIGS. 7A to 11.

According to an embodiment, the wearable electronic device 320 may be disposed on the outside of the case 310 and may be rested on the case 310. The wearable electronic device assembly 300 may include a protrusion 330 formed on the case 310, and the wearable electronic device 320 may be rested on the protrusion 330. The wearable electronic device 320 may be rested on the protrusion 330 such that the port 323 faces downward. The wearable electronic device 320 may be rested on the protrusion 330 such that the first housing 321 is positioned on the upper side of the second housing 322. The wearable electronic device 320 may be rested on the protrusion 330 such that the grille 324 is exposed in a direction toward the outside of the case 310. A wearable electronic device 320 may be seated in a recess (e.g., the recess 340 in FIG. 3).

According to an embodiment, referring to FIG. 3, the first housing 321 may be seated in the recess 340 on the second housing 322, and the second housing 322 may be seated on the protrusion 330. For example, a surface of the first housing 321 may be in contact with a surface of the recess 340, and a portion of the first housing 321 may be formed to be convex toward the recess 340. For example, a lower surface of the second housing 322 may be seated on the seating portion 333 of the protrusion 330. The surface of the second housing 322 may be supported by the first surface 331 and the second surface 332. A portion of the first housing 321 may be seated on the first surface 331. For example, the port 323 may be inserted into the groove 335. The groove 335 may surround the port 323. A portion of the port 323 may be inserted into the stepped portion 336 and latched on the stepped portion 336.

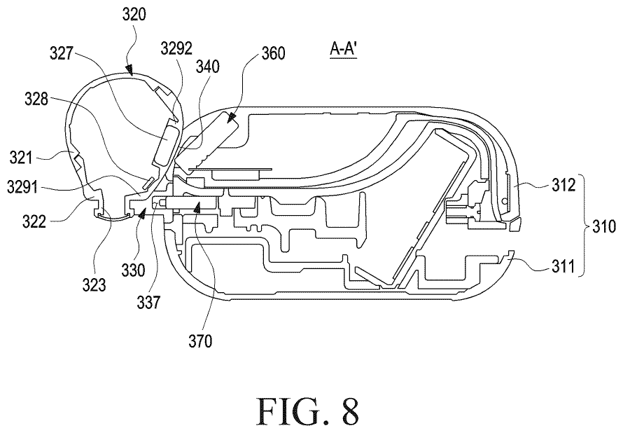

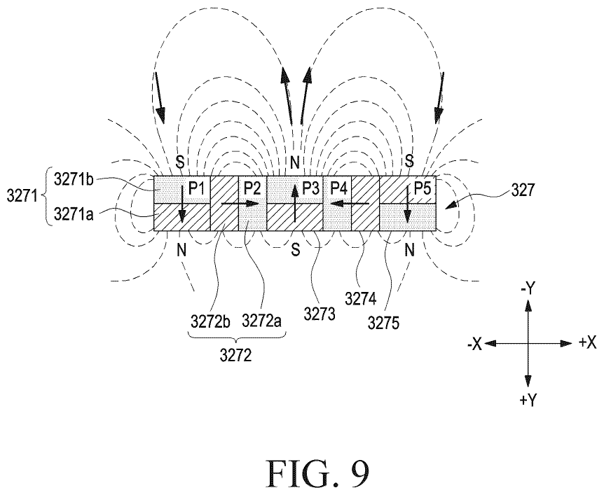

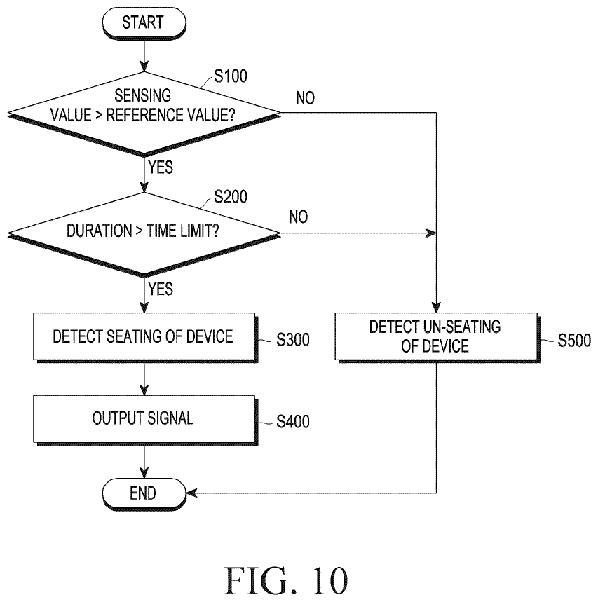

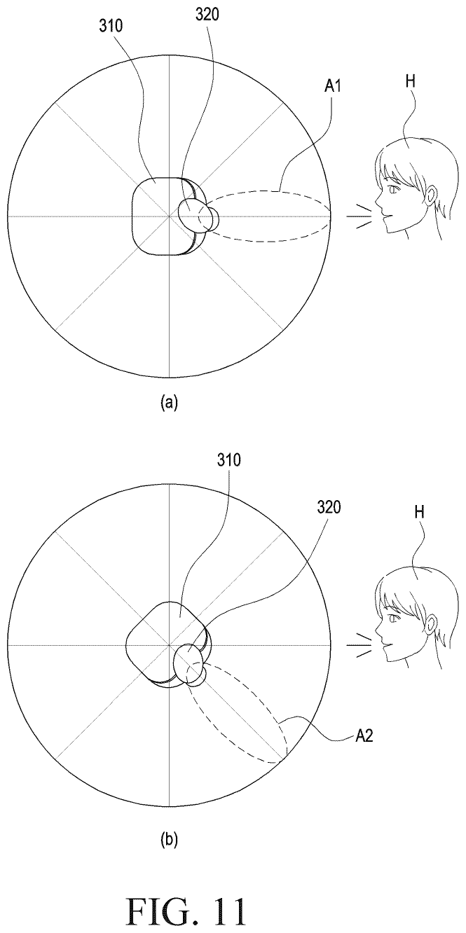

FIG. 7A is a diagram illustrating an internal structure with a part of the wearable electronic device 320 removed. FIG. 7B is a diagram illustrating an internal structure with the housing 329 of the wearable electronic device 320 removed. FIG. 8 is a sectional diagram taken along line A-A′ shown in FIG. 6D. FIG. 9 is a diagram explaining the magnetic force distribution of a second magnet 327 according to an embodiment of the disclosure. Components to be described with reference to FIGS. 7A, 7B, 8, and 9 may be entirely or partially identical to components having been described with reference to FIGS. 1 to 6D. Components to be described with reference to FIGS. 7A, 7B, 8, and 9 may be entirely or partially identical to components to be described with reference to FIGS. 10 and 11.

According to an embodiment, the wearable electronic device 320 may include speaker 326 disposed inside the housing 329. Sounds output from the speaker 326 may be transmitted to the outside of the housing 329 through the port 323. The wearable electronic device 320 may include a microphone 325. The microphone 325 may receive a sound from the outside of the housing 329 through the grille 324.

According to an embodiment, a plurality of microphones 325 may be arranged. The microphones 325 may include a first microphone 3251 and a second microphone 3252 that are spaced apart from each other. The microphones 325 may be positioned further from the port 323 than the speaker 326. Each of the first microphone 3251 and the second microphone 3252 may receive sounds outside the housing 329.

According to an embodiment, the wearable electronic device 320 may include a second magnet 327. The second magnet 327 may be disposed inside the housing 329.

The second magnet 327 may be disposed to face an outer surface of the first housing 321. The second magnet 327 may be spaced apart from the microphone 325 and the speaker 326.

According to an embodiment, when the wearable electronic device 320 is rested on the outside the case 310, the second magnet 327 may be positioned to correspond to the recess 340. The housing 329 may include a first portion 3292 surrounding at least a portion of the second magnet 327. The first portion 3292 may be positioned between the second magnet 327 and the recess 340 in a state where the wearable electronic device 320 is rested on the outside the case 310. The first magnet 360 disposed inside the case 310 may generate a magnetic force with the second magnet 327 of the wearable electronic device 320. In the state where the wearable electronic device 320 is rested on the outside the case 310, the recess 340 and the first portion 3292 may be positioned between the first magnet 360 and the second magnet 327. The wearable electronic device 320 may be fixed to the case 310 by the magnetic force between the first magnet 360 and the second magnet 327.

According to an embodiment, the second magnet 327 may be divided into a plurality of magnet portions 3271, 3272, 3273, 3274, and 3275. Each of the plurality of magnet portions 3271, 3272, 3273, 3274, and 3275 may have different polarities (e.g., N pole and S pole). The second magnet 327 may include a first magnet portion 3271 including a first polarity portion 3271a of the first magnet portion 3271 and a second polarity portion 3271b of the first magnet portion 3271 having opposite polarities. The second magnet 327 may include a second magnet portion 3272 including a first polarity portion 3272a of the second magnet portion 3272 and a second polarity portion 3272b of the second magnet portion 3272 having opposite polarities. The direction in which the first polarity portion 3271a and the second polarity portion 3271b of the first magnet portion 3271 are arranged or stacked may be orthogonal to the direction in which the first polarity portion 3272a and the second polarity portion 3272b of the second magnet portion 3272 are arranged or stacked. That is, the polarization axis of the first magnet portion 3271 and the polarization axis of the second magnet portion 3272 are oriented at 90 degrees to one another. For example, the first polarity portion 3271a and the second polarity portion 3271b of the first magnet portion 3271 may be arranged or stacked in the Y direction, and the first polarity portion 3272a and the second polarity portion 3272b of the second magnet portion 3272 may be arranged or stacked in the X direction. The direction P1 of the magnetic force generated in the first magnet portion 3271 and the direction P2 of the magnetic force generated in the second magnet portion 3272 may be orthogonal to each other. Each of the plurality of magnet portions 3271, 3272, 3273, 3274, and 3275 may generate a magnetic force. The directions of the magnetic forces generated by the magnet portions 3271, 3272, 3273, 3274, and 3275 located adjacent to each other may be orthogonal to each other. For example, the direction P3 of the magnetic force generated by the third magnet portion 3273 may be orthogonal to the direction P2 of the magnetic force generated by the second magnet portion 3272 and the direction P3 of the magnetic force generated by the fourth magnet portion 3274. For example, the first magnet portion 3271 may generate a magnetic force in a first direction (+Y), the second magnet portion 3272 may generate a magnetic force in a second direction (+X), a third magnet portion 3273 may generate a magnetic force in a third direction (−Y), a fourth magnet portion 3274 may generate a magnetic force in a fourth direction (−X), and a fifth magnet portion 3275 may generate a magnetic force in a fifth direction (+Y). Due to the above-described structure, the bonding force between the second magnet 327 and the first magnet 360 may be strengthened.

According to an embodiment, the wearable electronic device assembly 300 may include a sensing member 370 or 328. The sensing member 370 or 328 may be disposed in at least one of the case 310 and the wearable electronic device 320. The wearable electronic device 320 may include a first sensing member 328. The first sensing member 328 may be disposed inside the housing 329. The first sensing member 328 may be disposed at a position corresponding to the protrusion 330. The housing 329 may include a second portion 3291 coupled to the first sensing member 328. In a state where the wearable electronic device 320 is rested on the case 310, the second portion 3291 may be positioned between the protrusion 330 and the first sensing member 328. The wearable electronic device assembly 300 may include a second sensing member 370. The second sensing member 370 may be disposed inside the case 310. The second sensing member 370 may be disposed at a position corresponding to the protrusion 330. In a state where the wearable electronic device 320 is rested on the case 310, the protrusion 330 and the second portion 3291 may be positioned between the first sensing member 328 and the second sensing member 370. The protrusion 330 may include or define a space 337. A portion of the second sensing member 370 may be located within the space 337. The space 337 may be a space formed to be recessed into the protrusion 330.

FIG. 10 is a block diagram illustrating a process of recognizing a mounting state of a wearable electronic device 320 according to an embodiment of the disclosure. Components to be described with reference to FIG. 10 may be entirely or partially identical to components having been described with reference to FIGS. 1 to 9. Components to be described with reference to FIG. 10 may be entirely or partially identical to components to be described with reference to FIG. 11.

According to an embodiment, the wearable electronic device assembly 300 may correspond to the electronic device shown in FIG. 1. The wearable electronic device assembly 300 may include a processor 120. The processor 120 may be electrically connected to each of the first and second sensing members 328 and 370. The processor 120 may be electrically connected to a speaker (e.g., the speaker 326 in FIG. 7A). The processor 120 may receive signals generated from the first and second sensing members 328 and 370. The processor 120 may transmit or output signals to the speaker 326.

According to an embodiment, an operating method of the wearable electronic device assembly 300 may include a first process S100. In the first process S100, the processor 120 may compare a value sensed by the sensing member 328 or 370 with a preset reference value. When the value sensed by the sensing member 328 or 370 is greater than the reference value, the processor 120 may perform a second process S200. When the value sensed by the sensing member 328 or 370 is less than the reference value, the processor 120 may detect that the wearable electronic device 320 is not rested on the outside of the case 310 (S500).

According to an embodiment, an operating method of the wearable electronic device assembly 300 may include a second process S200. In the second process S200, the processor 120 may compare a duration during which a value sensed by the sensing member 328 or 370 exceeds a preconfigured reference value with a preconfigured time limit. When the duration is greater than the time limit, the processor 120 may perform a third process S300. When the duration is less than the time limit, the processor 120 may detect that the wearable electronic device 320 is not rested the outside of the case 310 (S500).

According to an embodiment, an operating method of the wearable electronic device assembly 300 may include a third process S300. In the third process S300, the processor 120 may detect that the wearable electronic device 320 is rested the outside of the case 310.

According to an embodiment, an operating method of the wearable electronic device assembly 300 may include a fourth process S400. In the fourth process S400, the processor 120 may transmit a signal to the speaker 326, and the speaker 326 may output an audio signal indicating that the wearable electronic device 320 is rested the outside of the case 310.

According to an embodiment, the first sensing member 328 may be a gravitational acceleration sensor. The first sensing member 328 may be a gyro sensor. The sensing value sensed by the first sensing member 328 may be greater than the reference value when the first housing 321 is located above the second housing 322 and the port 323 is located below the second housing 322. When the sensing value is greater than the reference value, the processor 120 may perform the second process S200.

According to an embodiment, the first sensing member 328 and the second sensing member 370 may be proximity sensors. The sensing values sensed by the first and second sensing members 328 and 370 may be greater than the reference value when the distance between the first sensing member 328 and the second sensing member 370 is less than a preconfigured limit distance. When the sensing value is greater than the reference value, the processor 120 may perform the second process S200.

According to an embodiment, the first sensing member 328 and the second sensing member 370 may be wireless charging devices. The sensing values sensed by the first and second sensing members 328 and 370 may be greater than the reference value when charging occurs between the first sensing member 328 and the second sensing member 370. When the sensing value is greater than the reference value, the processor 120 may perform the second process S200.

According to an embodiment, the second sensing member 370 may be a Pogo pin protruding outwardly from the protrusion 330. The sensing values sensed by the first and second sensing members 328 and 370 may be greater than the reference value when the second sensing member 370 is pressed by the wearable electronic device 320. When the sensing value is greater than the reference value, the processor 120 may perform the second process S200.

FIG. 11 is a diagram illustrating an effect of a wearable electronic device assembly 300 according to an embodiment of the disclosure. Part (a) of FIG. 11 is a diagram illustrating a state where a wearable electronic device 320 and a user H face each other, and part (b) of FIG. 11 is a diagram illustrating a state where the wearable electronic device 320 and the user H do not face each other. Components to be described with reference to FIG. 11 may be entirely or partially identical to components having been described with reference to FIGS. 1 to 10.

According to an embodiment of the disclosure, the wearable electronic device assembly 300 may selectively receive only a speech of user H facing the wearable electronic device 320 through a microphone (e.g., the microphone 325 in FIG. 7A) since the wearable electronic device 320 is seated in a fixed position of the case 310. For example, in a state such as part (a) of FIG. 11, a recognition area A1 may be generated between the wearable electronic device 320 and the user H, and the wearable electronic device 320 may selectively receive only a sound vibrating within the recognition area A1 through the microphone 325. In a state such as part (a) of FIG. 11, the microphone 325 of the wearable electronic device 320 may attenuate or cancel out a sound vibrating outside the recognition area A1 through a noise canceling (active noise cancellation) function. For example, in a state such as part (b) of FIG. 11, the wearable electronic device 320 may generate a recognition area A2 at a location that does not face the user H, and may not be able to receive the speech of the user H through the microphone 325.

The wearable electronic device may be accommodated inside a case defining a space therein. A microphone for picking up external sounds may be disposed inside the wearable electronic device, and a user may input sounds toward the microphone. In case that the wearable electronic device is placed inside the case, it is difficult to pick up external sounds through the microphone.

Embodiments of the disclosure provide an electronic device assembly configured to detachably rest a wearable electronic device on an exterior surface of a case.

Embodiments of the disclosure provide a mechanism to stably and firmly fix a wearable electronic device to the case.

It should be understood that the technical problems to be solved by the disclosure are not limited to those mentioned above, and may be variously defined within a range that does not deviate from the spirit and scope of the disclosure.

An electronic device according to various embodiments of the disclosure may rest a wearable electronic device on the outside of a case by seating the wearable electronic device on a protrusion formed at the case.

An electronic device according to various embodiments of the disclosure may firmly fix a wearable electronic device to a case by a magnetic force generated by a magnet.

It will be appreciated by a person skilled in the art that effects which may be achieved from the disclosure are not limited to the effects described above and other effects that are not described above will be clearly understood from the following detailed description.

A wearable electronic device assembly (e.g., 300 in FIGS. 1 to 11) according to an embodiment of the disclosure may include a wearable electronic device (e.g., 320 of FIGS. 1 to 11) including a speaker (e.g., 326 of FIGS. 1 to 11).

A wearable electronic device assembly (e.g., 300 of FIGS. 1 to 11) according to an embodiment of the disclosure may include a case (e.g., 310 of FIGS. 1 to 11) configured to accommodate the wearable electronic device (e.g., 320 of FIGS. 1 to 11).

A wearable electronic device (e.g., 320 of FIGS. 1 to 11) according to an embodiment of the disclosure may include a housing (e.g., 329 of FIGS. 1 to 11) in which a speaker (e.g., 326 of FIGS. 1 to 11) is disposed.

A wearable electronic device (e.g., 320 of FIGS. 1 to 11) according to an embodiment of the disclosure may include a microphone (e.g., 325 of FIGS. 1 to 11) disposed in the housing and spaced apart from the speaker (e.g., 329 of FIGS. 1 to 11).

A case (e.g., 310 of FIGS. 1 to 11) according to an embodiment of the disclosure may include a lower body (e.g., 311 of FIGS. 1 to 11) forming a space configured to accommodate the housing (e. include, 329 of FIGS. 1 to 11).

A case (e.g., 310 of FIGS. 1 to 11) according to an embodiment of the disclosure may include an upper body (e.g., 312 of FIGS. 1 to 11) rotatably coupled to the lower body (e.g., 311 of FIGS. 1 to 11).

A case (e.g., 310 of FIGS. 1 to 11) according to an embodiment of the disclosure may include a protrusion portion (e.g., 330 of FIGS. 1 to 11) protruding from the lower body (e.g., 311 of FIGS. 1 to 11) or the upper body (e.g., 312 of FIGS. 1 to 11) and where at least a portion of the housing is configured to be seated on the protrusion.

A protrusion (e.g., 330 of FIGS. 1 to 11) according to an embodiment of the disclosure may protrude from the lower body (e.g., 311 of FIGS. 1 to 11).

A case (e.g., 310 of FIGS. 1 to 11) according to an embodiment of the disclosure may include a recess (e.g., 340 of FIGS. 1 to 11) recessed toward the inside of the case (e.g., 310 of FIGS. 1 to 11).

A case (e.g., 310 of FIGS. 1 to 11) according to an embodiment of the disclosure may include a recess (e.g., 340 of FIGS. 1 to 11) spaced apart from the protrusion (e.g., 330 of FIGS. 1 to 11).

A case (e.g., 310 of FIGS. 1 to 11) according to an embodiment of the disclosure may include a boundary portion (e.g., 313 of FIGS. 1 to 11) formed between the protrusion (e.g., 330 of FIGS. 1 to 11) and the recess (e.g., 340 of FIGS. 1 to 11).

A wearable electronic device (e.g., 320 of FIGS. 1 to 11) according to an embodiment of the disclosure may include a port (e.g., 323 of FIGS. 1 to 11) protruding outwardly from the housing (e.g., 329 of FIGS. 1 to 11), and may be seated on the protrusion (e.g., 330 of FIGS. 1 to 11) such that the port (e.g., 323 of FIGS. 1 to 11) faces downward.

A wearable electronic device (e.g., 320 of FIGS. 1 to 11) according to an embodiment of the disclosure may include a grille (e.g., 324 of FIGS. 1 to 11) exposed to the outside of the housing (e.g., 310 of FIGS. 1 to 11) and facing the microphone (e.g., 325 of FIGS. 1 to 11), and may be seated on the protrusion (e.g., 330 of FIGS. 1 to 11) such that the grille (e.g., 324 of FIGS. 1 to 11) faces upward.

A protrusion (e.g., 330 of FIGS. 1 to 11) according to an embodiment of the disclosure may include a first surface (e.g., 331 of FIGS. 1 to 11) protruding from the case (e.g., 310 of FIGS. 1 to 11).

A protrusion (e.g., 330 of FIGS. 1 to 11) according to an embodiment of the disclosure may include a second surface (e.g., 332 of FIGS. 1 to 11) protruding from the case (e.g., 310 of FIGS. 1 to 11) and extending in a direction intersecting with the first surface (e.g., 331 of FIGS. 1 to 11).

A protrusion (e.g., 330 of FIGS. 1 to 11) according to an embodiment of the disclosure may include a seating portion (e.g., 333 of FIGS. 1 to 11) connected to the first surface (e.g., 331 of FIGS. 1 to 11) and the second surface (e.g., 332 of FIGS. 1 to 11) and formed concavely toward the case (e.g., 310 of FIGS. 1 to 11).

A wearable electronic device (e.g., 320 of FIGS. 1 to 11) according to an embodiment of the disclosure may include a port (e.g., 323 of FIGS. 1 to 11) protruding outward from the housing (e.g., 329 of FIGS. 1 to 11).

A protrusion (e.g., 330 of FIGS. 1 to 11) according to an embodiment of the disclosure may include a groove (e.g., 335 of FIGS. 1 to 11) into which the port (e.g., 323 of FIGS. 1 to 11) is inserted.

A protrusion (e.g., 330 of FIGS. 1 to 11) according to an embodiment of the disclosure may include a stepped portion (e.g., 336 of FIGS. 1 to 11) on which at least a portion of the port (e.g., 323 of FIGS. 1 to 11) is latched.

A wearable electronic device assembly (e.g., 300 of FIGS. 1 to 11) according to an embodiment of the disclosure may include a first magnet (e.g., 360 of FIGS. 1 to 11) disposed in the case (e.g., 310 of FIGS. 1 to 11).

A wearable electronic device assembly (e.g., 300 of FIGS. 1 to 11) according to an embodiment of the disclosure may include a second magnet (e.g., 327 of FIGS. 1 to 11) disposed in the housing (e.g., 329 of FIGS. 1 to 11) and having a magnetic polarity opposite to the first magnet (e.g., 360 of FIGS. 1 to 11).

A second magnet (e.g., 327 of FIGS. 1 to 11) according to an embodiment of the disclosure may include a plurality of magnet portions (e.g., 3271, 3272, 3273, 3274, and 3275 of FIGS. 1 to 11) including a first polarity portion (e.g., 3271a and 3272a of FIGS. 1 to 11) and a second polarity portion (e.g., 3271b and 3272b of FIGS. 1 to 11) opposite to the first polarity portion (e.g., 3271a and 3272a of FIGS. 1 to 11).

According to an embodiment of the disclosure, the polarization axes (e.g., P1, P2, P3, P4, and P5 of FIGS. 1 to 11) of magnet portions adjacent to each other among the plurality of magnet portions (e.g., 3271, 3272, 3273, 3274, and 3275 of FIGS. 1 to 11) may be orthogonal to each other.

A recess (e.g., 340 of FIGS. 1 to 11) according to an embodiment of the disclosure may be positioned between the first magnet (e.g., 327 of FIGS. 1 to 11) and the second magnet (e.g., 360 of FIGS. 1 to 11).

A wearable electronic device assembly (e.g., 300 of FIGS. 1 to 11) according to an embodiment of the disclosure may include a first sensing member (e.g., 328 of FIGS. 1 to 11) disposed in the housing (e.g., 329 of FIGS. 1 to 11).

A wearable electronic device assembly (e.g., 300 of FIGS. 1 to 11) according to an embodiment of the disclosure may include a processor (e.g., 120 of FIGS. 1 to 11) electrically connected to the first sensing member (e.g., 328 of FIGS. 1 to 11) and configured to sense a seating state of the wearable electronic device (e.g., 320 of FIGS. 1 to 11).

A wearable electronic device assembly (e.g., 300 of FIGS. 1 to 11) according to an embodiment of the disclosure may include a second sensing member (e.g., 370 of FIGS. 1 to 11) disposed in the case (e.g., 310 of FIGS. 1 to 11).

A wearable electronic device assembly (e.g., 300 of FIGS. 1 to 11) according to an embodiment of the disclosure may include a processor (e.g., 120 of FIGS. 1 to 11) electrically connected to the second sensing member (e.g., 370 of FIGS. 1 to 11) and configured to sense a seating state of the wearable electronic device (e.g., 320 of FIGS. 1 to 11).

A wearable electronic device assembly (e.g., 300 of FIGS. 1 to 11) according to an embodiment of the disclosure may include a sensing member (e.g., 328 or 370 of FIGS. 1 to 11) disposed in at least one of the housing (e.g., 329 of FIGS. 1 to 11) and the case (e.g., 310 of FIGS. 1 to 11).

A wearable electronic device assembly (e.g., 300 of FIGS. 1 to 11) according to an embodiment of the disclosure may include a processor (e.g., 120 of FIGS. 1 to 11) electrically connected to the sensing member (e.g., 328 or 370 of FIGS. 1 to 11) and the speaker (e.g., 326 of FIGS. 1 to 11), and configured to transfer a signal to the speaker (e.g., 326 of FIGS. 1 to 11) based on a value sensed by the sensing member (e.g., 328 or 370 of FIGS. 1 to 11).

A case (e.g., 310 of FIGS. 1 to 11) according to an embodiment of the disclosure may include a lower body (e.g., 311 of FIGS. 1 to 11) configured to accommodate a wearable electronic device (e.g., 320 of FIGS. 1 to 11) having a speaker (e.g., 326 of FIGS. 1 to 11) disposed therein.

A case (e.g., 310 of FIGS. 1 to 11) according to an embodiment of the disclosure may include an upper body (e.g., 312 of FIGS. 1 to 11) rotatably coupled to the lower body (e.g., 311 of FIGS. 1 to 11).

A case (e.g., 310 of FIGS. 1 to 11) according to an embodiment of the disclosure may include a protrusion (e.g., 330 of FIGS. 1 to 11) that protrudes from the lower body (e.g., 311 of FIGS. 1 to 11) or the upper body (e.g., 312 of FIGS. 1 to 11) and is configured to receive at least a portion of the wearable electronic device (e.g., 320 of FIGS. 1 to 11).

A case (e.g., 310 of FIGS. 1 to 11) according to an embodiment of the disclosure may include a recess (e.g., 340 of FIGS. 1 to 11) formed in the upper body (e.g., 312 of FIGS. 1 to 11) and configured to receive at least a portion of the housing (e.g., 329 of FIGS. 1 to 11).

According to an embodiment of the disclosure, the recess (e.g., 340 of FIGS. 1 to 11) may be recessed into the inner space of the case (e.g., 310 of FIGS. 1 to 11).

A case (e.g., 310 of FIGS. 1 to 11) according to an embodiment of the disclosure may include a protrusion (e.g., 330 of FIGS. 1 to 11) disposed at a position spaced apart from the recess (e.g., 340 of FIGS. 1 to 11) and extending outwardly of the case (e.g., 310 of FIGS. 1 to 11).

A wearable electronic device assembly (e.g., 300 of FIGS. 1 to 11) according to an embodiment of the disclosure may include a first magnet (e.g., 360 of FIGS. 1 to 11) disposed inside the case (e.g., 310 of FIGS. 1 to 11) and disposed at a position corresponding to the recess (e.g., 340 of FIGS. 1 to 11).

A case (e.g., 310 of FIGS. 1 to 11) according to an embodiment of the disclosure may include a lower body (e.g., 311 of FIGS. 1 to 11) defining a space for accommodating the wearable electronic device (e.g., 320 of FIGS. 1 to 11) therein.

A case (e.g., 310 of FIGS. 1 to 11) according to an embodiment of the disclosure may include a first magnet (e.g., 360 of FIGS. 1 to 11) having a first polarity.

The wearable electronic device (e.g., 320 of FIGS. 1 to 11) according to an embodiment of the disclosure may include a second magnet (e.g., 327 of FIGS. 1 to 11) disposed inside the housing (e.g., 329 of FIGS. 1 to 11) and having a second polarity opposite to the first polarity. The second magnet (e.g., 327 of FIGS. 1 to 11) may be configured to be magnetically attracted to the first magnet (e.g., 360 of FIGS. 1 to 11).

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A wearable electronic device assembly comprising:
a wearable electronic device including a speaker; and
a case configured to accommodate the wearable electronic device,
wherein the wearable electronic device comprises:
a housing in which the speaker is disposed; and
a microphone disposed in the housing and spaced apart from the speaker,
wherein the case comprises:
a lower body defining a space configured to accommodate the housing;
an upper body rotatably coupled to the lower body; and
a protrusion protruding outwardly from the lower body or the upper body, wherein at least a portion of the housing is configured to be seated on the protrusion while the upper body is in a closed state with respect to the lower body.

2. The wearable electronic device assembly of claim 1,
wherein the protrusion protrudes from the lower body.

3. The wearable electronic device assembly of claim 1,
wherein the case comprises:
a recess recessed from an outside of the case toward an inside of the case.

4. The wearable electronic device assembly of claim 1,
wherein the case comprises:
a recess spaced apart from the protrusion; and
a boundary portion formed between the protrusion and the recess.

5. The wearable electronic device assembly of claim 1,
wherein the wearable electronic device comprises a port protruding outwardly from the housing, and
wherein, when the housing is seated on the protrusion, the port configured to face downward with respect to the housing.

6. The wearable electronic device assembly of claim 1,
wherein the wearable electronic device comprises a grille exposed to an outside of the housing and facing the microphone, and is seated on the protrusion, such that the grille faces away from the protrusion.

7. The wearable electronic device assembly of claim 1,
wherein the protrusion comprises:
a first surface protruding from the case;
a second surface protruding from the case and extending in a direction intersecting with the first surface; and
a seating portion connected to the first surface and the second surface, and formed concavely toward the case.

8. The wearable electronic device assembly of claim 1,
wherein the wearable electronic device comprises a port protruding outwardly from the housing, and
wherein the protrusion comprises a groove into which the port is inserted.

9. The wearable electronic device assembly of claim 1,
wherein the wearable electronic device comprises a port protruding outwardly from the housing, and
wherein the protrusion comprises a stepped portion on which at least a portion of the port is latched.

10. The wearable electronic device assembly of claim 1, further comprising:
a first magnet disposed in the case; and
a second magnet disposed in the housing and configured to be magnetically attracted to the first magnet.

11. The wearable electronic device assembly of claim 10,
wherein the second magnet comprises:
a plurality of magnet portions including a first magnet polarity portion and a second magnet polarity portion opposite to the first magnet polarity portion, and
wherein polarization axes of magnet portions adjacent to each other among the plurality of magnet portions are orthogonal to each other.

12. The wearable electronic device assembly of claim 10,
wherein the case comprises a recess recessed toward an inside of the case,
wherein the recess is positioned between the first magnet and the second magnet.

13. The wearable electronic device assembly of claim 1, further comprising:
a first sensing member disposed in the housing; and
a processor electrically connected to the first sensing member and configured to sense a seating state of the wearable electronic device.

14. The wearable electronic device assembly of claim 1, further comprising:
a second sensing member disposed in the case; and
a processor electrically connected to the second sensing member and configured to sense a seating state of the wearable electronic device.

15. The wearable electronic device assembly of claim 1, further comprising:
a sensing member disposed in at least one selected from the housing and the case; and
a processor electrically connected to the sensing member and the speaker, and configured to output a signal to the speaker based on a value sensed in the sensing member.

16. The wearable electronic device assembly of claim 15,
wherein the processor outputs the signal to the speaker when the value sensed in the sensing member is greater than a reference value.

17. A wearable electronic device assembly comprising:
a wearable electronic device including a speaker; and
a case configured to accommodate the wearable electronic device,
wherein the wearable electronic device comprises:
a housing in which the speaker is disposed; and
a microphone disposed in the housing and spaced apart from the speaker,
wherein the case comprises:
a lower body defining a space configured to accommodate the housing;
an upper body rotatably coupled to the lower body; and
a recess recessed on the upper body and configured such that at least a portion of the housing is seated therein.

18. The wearable electronic device of claim 17, wherein the recess recessed from the outside of the case toward an inside of the case.

19. The wearable electronic device of claim 17, wherein the case includes a protrusion spaced apart from the recess and protruding outwardly from an outside of the case.

20. The wearable electronic device of claim 17, comprising a first magnet disposed in the case and disposed at a position corresponding to the recess.
